(19) United States
(12) Patent Application Publication
(10) Pub. No.: US 2024/0123667 A1
(43) Pub. Date: Apr. 18, 2024

(54) MOVING-BODY MONITORING DEVICE

(71) Applicant: FANUC CORPORATION, Minamitsuru-gun, Yamanashi (JP)

(72) Inventor: Tarou OGISO, Minamitsuru-gun, Yamanashi (JP)

(21) Appl. No.: 18/286,620

(22) PCT Filed: Jun. 29, 2021
(86) PCT No.: PCT/JP2021/024573

§ 371 Date: Oct. 12, 2023

(51) Int. Cl. B29C 45/80; B29C 45/76

(52) U.S. Cl. CPC B29C 45/80; B29C 45/7626

(57) ABSTRACT

A moving-body monitoring device has a position detection unit that outputs positional information of a moving body, a proximity sensor that detects the moving body, a first storage unit that stores a position when the moving body having moved in a first direction is detected as first positional information, and stores a position when the moving body having moved in a second direction is detected as second positional information, and a calculation unit that calculates a fixed-point position of a detecting region of the proximity sensor during monitoring as fixed-point positional information based on the first and second positional information. The device also has a second storage unit that stores reference fixed-point positional information, and a monitoring unit that, when a deviation between the fixed-point and reference fixed-point positional information goes beyond a stipulated range, determines that a positional deviation amount of the moving body exceeds a tolerance.

### TECHNICAL FIELD

The present invention relates to a moving-body monitoring device.

### BACKGROUND ART

Many of the devices such as machine tools, industrial robots, and molding machines include a plurality of movable parts. For instance, an injection molding machine includes movable parts such as an injection device, a mold clamping device, and an ejector device. These movable parts include a power transmission mechanism that transmits a driving force of the motor to a moving body (driven object). As an example of such a power transmission mechanism, a mechanism in an ejector device of an injection molding machine is known, in which a driving force is transmitted from a drive shaft of a single motor to a plurality of driven shafts through a timing belt, and a ball screw is driven via a pulley connected to the driven shafts (for example, refer to Patent Document 1). In this mechanism, the moving body reciprocates by driving the ball screw.
Patent Document 1: Japanese Unexamined Patent Application, Publication No. 2010-284931

### DISCLOSURE OF THE INVENTION

### Problems to be Solved by the Invention

In the power transmission mechanism as described above, if tooth skipping (jumping) occurs between the timing belt and the driven pulley, a positional deviation arises between the position of the moving body detected by the rotary encoder on the motor side and the actual position of the moving body. Conventionally, proximity sensors are often used as sensors for detecting a positional deviation of a moving body. Proximity sensors are provided in the travel path of the moving body that reciprocates by the driving of the ball screw.

Proximity sensors are relatively inexpensive but characterized in varying the size of the detection area due to the factors such as environmental temperature and power supply voltage. In an environment where proximity sensors are installed, if the temperature difference between winter and summer is large, the rate of change in the detection distance of the proximity sensor would be, for example, approximately 10-odd %. Therefore, when the minimum positional deviation of the moving body caused by tooth skipping falls within the range of the change rate of the proximity sensor, it is difficult to accurately determine the presence or absence of a positional deviation of the moving body, which is a problem.

The objective of the present invention is to provide a moving-body monitoring device that can determine the presence or absence of a positional deviation of a moving body more accurately.

### Means for Solving the Problems

One aspect of the present invention is a monitoring device for a moving body that reciprocates in a first direction and a second direction opposite to the first direction, in which the monitoring device includes: a position detection unit that detects a position of the moving body and outputs the position as positional information; a proximity sensor that detects passage of the moving body at a specific position; a first storage unit that stores a position of the moving body when the moving body moving in the first direction is detected by the proximity sensor, as first positional information, and stores a position of the moving body when the moving body moving in the second direction is detected by the proximity sensor, as second positional information; a calculation unit that calculates a fixed-point position in a detection area of the proximity sensor during monitoring, as fixed-point positional information, based on at least one of the first positional information and at least one of the second positional information stored in the first storage unit; a second storage unit that stores reference fixed-point positional information; and a monitoring unit that determines that an amount of positional deviation of the moving body exceeds tolerance when a deviation between the fixed-point positional information calculated by the calculation unit when monitoring the moving body and the reference fixed-point positional information stored in the second storage unit falls out of a prescribed range.

### Effects of the Invention

With the moving-body monitoring device according to the present invention, the presence or absence of a positional deviation of a moving body can be determined more accurately.

### BRIEF DESCRIPTION OF THE DRAWINGS

FIG. 1 is a block diagram illustrating a system configuration of an ejector device 1;

FIG. 2 is a diagram illustrating an operation of a proximity sensor 22 when a table 15 is moved in two directions;

FIG. 3 is a diagram illustrating an operation of the proximity sensor 22 when the table 15 is moved in one direction; and

FIG. 4 is a flowchart illustrating the procedure of detecting a positional deviation of the table 15 in the ejector device 1 of the embodiment.

### PREFERRED MODE FOR CARRYING OUT THE INVENTION

Hereinafter, an embodiment of a moving-body monitoring device according to the present invention, as applied to an ejector device of an injection molding machine, will be described. The ejector device is a device having a function to extract molded products from a mold inside a mold clamping device (not illustrated) in the injection molding machine.

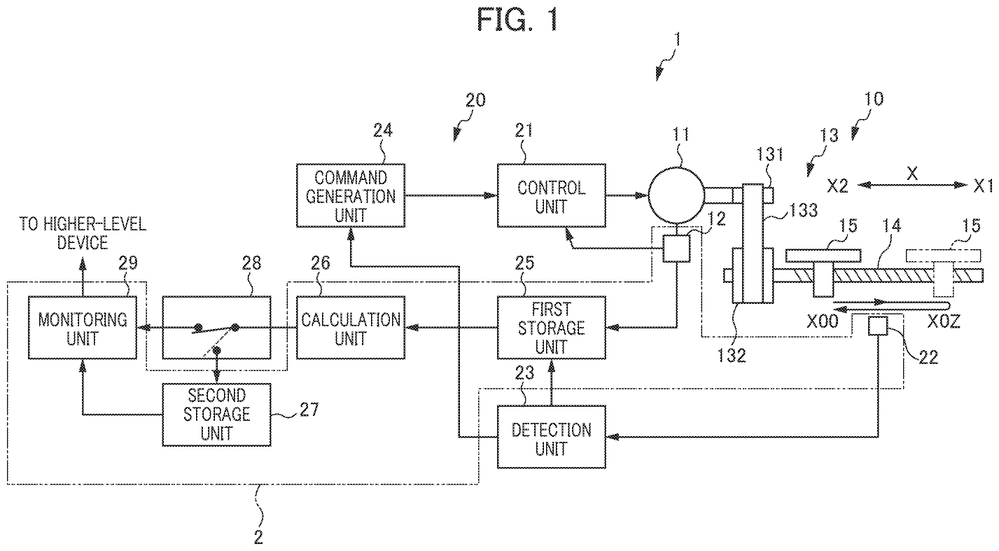

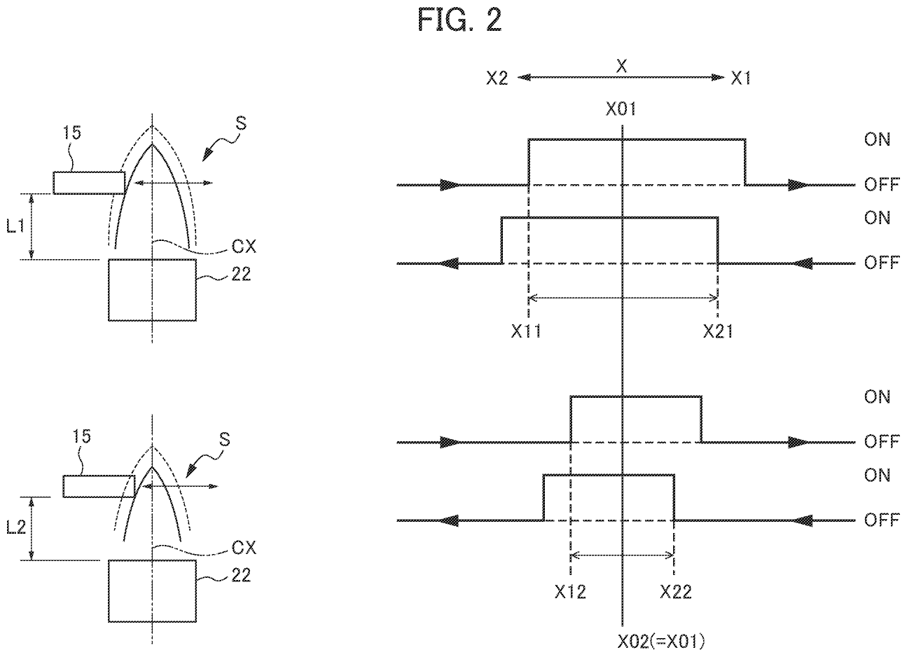

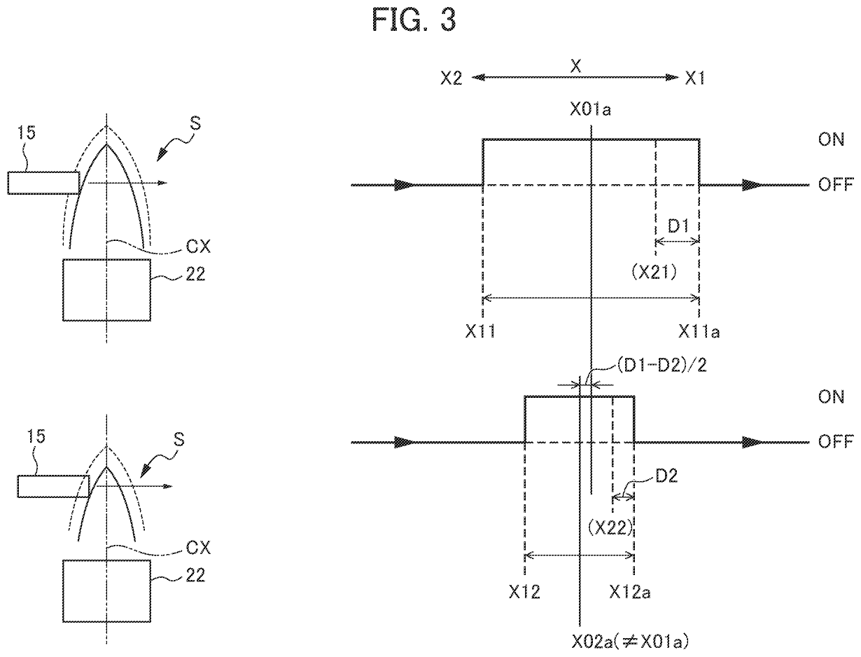

FIG. 1 is a block diagram illustrating the system configuration of the ejector device 1. FIG. 2 is a diagram illustrating an operation of a proximity sensor 22 when a table 15 is moved in two directions. FIG. 3 is a diagram illustrating an operation of the proximity sensor 22 when the table 15 is moved in one direction.

Note that all the drawings attached to this specification are schematic diagrams, and the shapes, scales, aspect ratios, etc., of each part are changed or exaggerated from the actual objects for the sake of ease of understanding. In this specification, terms specifying shapes, geometric conditions, and their degrees include not only the strict sense of the terms; for example, the term “direction” may include ranges that can be approximately considered to be in that direction.

As illustrated in FIG. 1, the ejector device 1 includes a movable mechanism 10 and a control device 20. The movable mechanism 10 includes a motor 11, a position detection unit 12, a power transmission unit 13, a ball screw 14, and a table (moving body) 15. In FIG. 1, the configuration of the movable mechanism 10 illustrates only the parts necessary for describing the moving-body monitoring device according to the present invention.

The motor 11 is a power source that generates a rotational force for driving the ball screw 14. The motor 11 is configured with a servo motor. The position detection unit 12 is provided on the motor 11. The position detection unit 12 is a detection device that detects a position of the table 15 (described later) and outputs the position as positional information. The position detection unit 12 counts the number of pulses generated by the rotation of the motor 11 and outputs the positional information on the table 15 on the ball screw 14 as the pulse number corresponding to the rotation angle of the motor 11. The position detection unit 12 is configured with, for example, a rotary encoder. The positional signal outputted from the position detection unit 12 is sent as a semi-closed feedback signal to the control unit 21, and is also sent to the first storage unit 25.

The power transmission unit 13 is a mechanism that transmits a rotational force generated by the motor 11 to the ball screw 14. The power transmission unit 13 includes a driving pulley 131, a driven pulley 132, and a timing belt 133. The driving pulley 131 is a pulley provided on the drive shaft of the motor 11. The driven pulley 132 is a pulley connected to the ball screw 14. A plurality of driven pulleys 132 are provided on the ball screw 14 in many cases; however, FIG. 1 illustrates a simplified configuration in which one driven pulley 132 is connected to the ball screw 14. The timing belt 133 is an endless belt that transmits a rotational force of the driving pulley 131 to the driven pulley 132. The timing belt 133 is stretched between the driving pulley 131 and the driven pulley 132.

The ball screw 14 is a mechanism that converts a rotational motion generated by the motor 11 into a linear motion. The table 15 is connected to the ball screw 14. The rotation of the motor 11 is controlled so as to rotate the ball screw 14 in the forward or reverse direction, allowing the table 15 to reciprocate. In this specification, etc., the moving direction of the table 15 is defined as the X direction. In the X direction, the direction in which the table 15 moves away from the driven pulley 132 is defined as the X1 direction (first direction), and the direction in which the table 15 approaches the driven pulley 132 is defined as the X2 direction (second direction), which is opposite to the X1 direction. In this specification, the term “˜ direction” is also referred to as “˜ side” as appropriate.

The table 15 is a moving body connected to an ejector rod (not illustrated) that enters and exits the mold. When the table 15 moves in the X1 direction, the tip of the ejector rod advances and protrudes into the mold, pushing the molded product out of the mold. When the table 15 moves in the X2 direction, the tip of the ejector rod retracts to a predetermined position within the mold. In this manner, the ejector rod advances/retracts in conjunction with the reciprocating motion of the table 15, allowing the molded product to be removed from the mold for each molding cycle. In FIG. 1, the base point serving as the origin position of the table 15 is represented as “X00”, and the end point where the table 15 returns after moving in the X1 direction is represented as “X0Z”. FIG. 1 schematically illustrates each of the states where the table 15 is positioned at the base point X00 or the end point X0Z.

The control device 20 includes the control unit 21, the proximity sensor 22, a detection unit 23, a command generation unit 24, a first storage unit 25, a calculation unit 26, a second storage unit 27, a fixed-point position selection unit 28, and a monitoring unit 29. In FIG. 1, the position detection unit 12, the proximity sensor 22, the first storage unit 25, the calculation unit 26, the second storage unit 27, and the monitoring unit 29 configure the moving-body monitoring device 2 in the present embodiment.

The control unit 21 is a control unit that controls the driving of the motor 11, based on the operation command generated by the command generation unit 24, and is configured with a microprocessor that includes a CPU (central processing unit), memory, etc. The functions of the control unit 21 may be implemented by hardware and software in collaboration, or may be implemented by hardware (electronic circuit) alone.

The proximity sensor 22 is a sensor that contactlessly detects passage of the table 15 at a specific position on the ball screw 14. The signal outputted from the proximity sensor 22 changes to either an ON (operating) level or an OFF (returning) level, depending on the detection result. When the table 15 enters the detection area (described later) of the proximity sensor 22, the signal outputted from the proximity sensor 22 changes to the ON level. On the other hand, when the table 15 moves away from the detection area of the proximity sensor 22, the signal outputted from the proximity sensor 22 changes to the OFF level. In this specification, etc., as illustrated in FIGS. 2 and 3 (described later), the line passing through the center of the proximity sensor 22 is described as the “reference axis CX”.

The detection unit 23 detects whether the table 15 has approached or moved away from the proximity sensor 22, based on the level (ON/OFF) of the signal outputted from the proximity sensor 22. When the signal outputted from the proximity sensor 22 changes from the OFF level to the ON level, the detection unit 23 sends a detection signal to the command generation unit 24 and the first storage unit 25.

The command generation unit 24 generates an operation command for the control unit 21 to drive the motor 11. An operation program describing the operation of the ejector device 1 is given to the command generation unit 24. The command generation unit 24 generates an operation command, based on the given operation program. For example, the command generation unit 24 generates an operation command to drive the ball screw 14 by the motor 11 such that the table 15 approaches the proximity sensor 22. The command generation unit 24 generates an operation command to drive the ball screw 14 by the motor 11 such that the table 15 moves away from the proximity sensor 22. The operation command generated by the command generation unit 24 is sent to the control unit 21. The command generation unit 24 sends the operation command to the control unit 21, whereby controlling the rotation direction, the rotation speed, the rotation amount (rotation angle), etc. of the motor 11. As a result, in one cycle of molding, the ejector rod (not illustrated) connected to the table 15 is controlled to advance/retract.

The first storage unit 25 is a storage device that stores positional information on the table 15, etc. The first storage unit 25 stores, as the first positional information, the position of the table 15 when the table 15 moving in the X1 direction (first direction) by the ball screw 14 is detected by the proximity sensor 22. The first storage unit 25 stores, as the second positional information, the position of the table 15 when the table 15 moving in the X2 direction (second direction) by the ball screw 14 is detected by the proximity sensor 22. The first storage unit 25 stores information on a prescribed range which is used by the monitoring unit 29 to determine the degree of deviation between the fixed-point positional information calculated by the calculation unit 26 and the reference fixed-point positional information stored in the second storage unit 27. The information on the prescribed range may be stored not only in the first storage unit 25 but also in the monitoring unit 29, or in another storage unit.

The first storage unit 25 stores, as the first positional information, the positional information indicating the position of the table 15 which is sent from the position detection unit 12 when receiving a detection signal from the detection unit 23. The same applies to the second positional information. Note that the first storage unit 25 may store one set or a plurality of sets of the first and second positional information. Storing a plurality of sets of the first and second positional information refers to that the table 15 consecutively reciprocates a plurality of times, and the first and second positional information are associated with each other and stored for each reciprocation.

As described above, the size of the detection area S of the proximity sensor 22 changes due to the factors such as environmental temperature and power supply voltage. FIG. 2 illustrates, in two different detection areas S having different sizes, the change in the level of signals outputted from the proximity sensor 22 when the table 15 reciprocates in two directions (X1 and X2 directions). The upper diagram of FIG. 2 illustrates the change in the level of signals when the detection area S of the proximity sensor 22 is large. The lower diagram of FIG. 2 illustrates the change in the level of signals when the detection area S of the proximity sensor 22 is small. The time axes in the upper and lower diagrams of FIG. 2 are identical in the timing charts illustrating the change in the level of signals.

In FIG. 2, the solid line and the dashed line indicate the ranges of the detection area S of the proximity sensor 22. In the detection area S, the portion indicated by the solid line is the range where the signal outputted from the proximity sensor 22 changes to the ON level. The portion indicated by the dashed line is the range where the signal outputted from the proximity sensor 22 changes to the OFF level. As illustrated in FIG. 2, the signal outputted from the proximity sensor 22 changes to the ON level when the table 15 approaches the proximity sensor 22 and enters the range indicated by the solid line in the detection area S, and changes to the OFF level when the table 15 moves away from the proximity sensor 22 and exits the range indicated by the dashed line in the detection area S.

As illustrated in FIG. 2, when the table 15 moving from the base point side (X2 side) in the X1 direction is detected by the proximity sensor 22 at a position X11, the signal outputted from the proximity sensor 22 changes from the OFF level to the ON level at the position X11. The first storage unit 25 stores, as the first positional information, the position X11 of the table 15 when detected by the proximity sensor 22. When the table 15 further moves away from the proximity sensor 22 in the X1 direction and is no longer detected by the proximity sensor 22, the signal outputted from the proximity sensor 22 changes from the ON level to the OFF level.

On the other hand, when the table 15 moving from the end point side (X1 side) in the X2 direction is detected by the proximity sensor 22 at a position X21, the signal outputted from the proximity sensor 22 changes from the OFF level to the ON level at the position X21. The first storage unit 25 stores, as the second positional information, the position X21 of the table 15 when detected by the proximity sensor 22. When the table 15 further moves away from the proximity sensor 22 in the X2 direction and is no longer detected by the proximity sensor 22, the signal outputted from the proximity sensor 22 changes from the ON level to the OFF level. The relationship between the size of the detection area S and the change in the level of signals outputted from the proximity sensor 22 in the upper and lower diagrams of FIG. 2 will be described later.

The calculation unit 26 calculates, as fixed-point positional information, a fixed-point position in the detection area S of the proximity sensor 22 when monitoring the positional deviation, based on the first and second positional information stored in first storage unit 25. The fixed-point position is the position X01 in the upper diagram of FIG. 2, and is the position X02 in the lower diagram of FIG. 2. Hereafter, the fixed-point positions X01 and X02 are also collectively referred to as “fixed-point position X0k”. The calculation unit 26 calculates the fixed-point position X0k as an average value of the position of the table 15 represented by the first positional information and the position of the table 15 represented by the second positional information. The fixed-point positional information calculated by the calculation unit 26 is sent to the monitoring unit 29.

In the case where the calculation unit 26 calculates the fixed-point positional information, based on a plurality of sets of the first and second positional information, when a necessary amount of the first and second positional information is stored in the first storage unit 25, the calculation unit 26 calculates the fixed-point positional information, based on these positional information. For example, the fixed-point position may be calculated for each of a plurality of sets of the first and second positional information, and an average value of the plurality of fixed-point positions may be used as the final fixed-point positional information.

For example, in the upper diagram of FIG. 2, when the table 15 moving in the X1 direction is detected by the proximity sensor 22 at the position X11, assume the distance from the base point (position X00 in FIG. 1) to the position X11 is 500 mm. After the table 15 returned at the end point, when the table 15 moving in the X2 direction is detected by the proximity sensor 22 at the position X21, assume the distance from the base point to the position X21 is 800 mm, then the distance from the base point to the fixed-point position X01 calculated by the calculation unit 26 will be 650 mm. Similarly, in the lower diagram of FIG. 2, when the table 15 moving in the X1 direction is detected by the proximity sensor 22 at the position X12, assume the distance from the base point to the position X12 is 600 mm. After the table 15 returned at the end point, when the table 15 moving in the X2 direction is detected by the proximity sensor 22 at the position X22, assume the distance from the base point to the position X22 is 700 mm, then the distance from the base point to the fixed-point position X02 calculated by the calculation unit 26 will be 650 mm.

As illustrated in FIG. 2, even if the size of the detection area S of the proximity sensor 22 changes due to the factors such as environmental temperature and power supply voltage, as long as the shape of the detection area S is line-symmetric to the reference axis CX, the fixed-point position X0k remains the same (X01=X02) regardless of the size of the detection area S. As illustrated in FIG. 2, this characteristic applies not only to the case where the distances L1 and L2 between the table 15 and the proximity sensor 22 are the same and the size of the detection area S of the proximity sensor 22 changes, but also to the case where the size of the detection area S is the same and the distances L1 and L2 between the table 15 and the proximity sensor 22 change (L1>L2 or L1<L2).

Here, for comparison, a description is provided on the operation of the proximity sensor 22 when the table 15 is moved in one direction. FIG. 3 illustrates the change in the level of signals outputted from the proximity sensor 22 when the table 15 is moved in one direction (for example, in the X1 direction). The upper diagram of FIG. 3 illustrates the change in the level of signals when the detection area S of the proximity sensor 22 is large. The lower diagram of FIG. 3 illustrates the change in the level of signals when the detection area S of the proximity sensor 22 is small. The time axes in the upper and lower diagrams of FIG. 3 are identical in the timing charts illustrating the change in the level of signals.

In the upper diagram of FIG. 3, when the table 15 moving from the base point side in the X1 direction is detected by the proximity sensor 22 at the position X11, the signal outputted from the proximity sensor 22 changes from the OFF level to the ON level at the position X11. In this detection example, the position X11 of the table 15 when detected by the proximity sensor 22 serves as the first positional information. Thereafter, when the table 15 moves away from the proximity sensor 22 in the X1 direction and is no longer detected by the proximity sensor 22, the signal outputted from the proximity sensor 22 changes from the ON level to the OFF level. In this detection example, the position X11a of the table 15, when the table 15 moving in the X1 direction is no longer detected by the proximity sensor 22, serves as the second positional information.

In the operation example illustrated in the upper diagram of FIG. 3, when an average value of the position X11 of the table 15 represented by the first positional information and the position X11a of the table 15 represented by the second positional information is calculated, the fixed-point position will be X01a. Here, although not illustrated in the upper diagram of FIG. 3, when the proximity sensor 22 is moved from the end point side (X1 side) in the X2 direction, if the table 15 is detected by the proximity sensor 22 at the position X21, which is the same position as in the upper diagram of FIG. 2, the hysteresis will be D1. The hysteresis refers to a difference between the position at which the signal level changes to ON when the table 15 approaches the proximity sensor 22 and the position at which the signal level changes to OFF when the table 15 moves away from the proximity sensor 22. The impact of the hysteresis will be described later.

On the other hand, in the lower diagram of FIG. 3, when the table 15 moving from the base point side in the X1 direction is detected by the proximity sensor 22 at the position X12, the signal outputted from the proximity sensor 22 changes from the OFF level to the ON level at the position X12. In this detection example, the position X12 of the table 15 when detected by the proximity sensor 22 serves as the first positional information. Thereafter, when the table 15 moves away from the proximity sensor 22 in the X1 direction and is no longer detected by the proximity sensor 22, the signal outputted from the proximity sensor 22 changes from the ON level to the OFF level. In this detection example, the position X12a of the table 15, when the table 15 moving in the X1 direction is no longer detected by the proximity sensor 22, serves as the second positional information.

In the operation example illustrated in the lower diagram of FIG. 3, when an average value of the position X12 of the table 15 represented by the first positional information and the position X12a of the table 15 represented by the second positional information is calculated, the fixed-point position will be X02a. Here, although not illustrated in the lower diagram of FIG. 3, when the proximity sensor 22 is moved in the X2 direction from the end point side (X1 side), if the table 15 is detected by the proximity sensor 22 at the position X22, which is the same position as in the lower diagram of FIG. 2, the hysteresis will be D2.

Comparing the upper and lower diagrams of FIG. 3, the fixed-point position X01a calculated under the condition of the upper diagram and the fixed-point position X02a calculated under the condition of the lower diagram do not match, and the position will deviate by ½ times the amount of the change in hysteresis (D1−D2). This is because the hysteresis also changes (D1>D2) in proportion to the change in the size of the detection area S. When the fixed-point position is calculated based on the first and second positional information detected when the table 15 is moved in one direction, if the size of the detection area S changes, the fixed-point position will deviate as affected by the hysteresis. In this manner, in this detection example, when the size of the detection area S changes due to the influence of the factors such as environmental temperature and power supply voltage, the accuracy of detecting the positional deviation of the table 15 will decrease.

On the other hand, in the present embodiment, as illustrated in FIG. 2, the calculation unit 26 calculates the fixed-point position, based on the first and second positional information detected when the table 15 reciprocates in two directions. According to this, even if the size of the detection area S changes, the fixed-point position can be accurately calculated without being affected by the hysteresis, whereby improving the accuracy of detecting the positional deviation of the table 15.

Returning again to FIG. 1, a description is provided below. The second storage unit 27 stores, as the reference fixed-point positional information, the fixed-point positional information calculated by the calculation unit 26 when calibrating the fixed-point position. Calibrating the fixed-point position refers to the process of registering the correct fixed-point position as a reference, before monitoring the deviation of the fixed-point position. The timing of calibrating the fixed-point position may be, for example, when setting up the ejector device 1. When setting up the ejector device 1, each part of the power transmission unit 13 is adjusted to the normal state, the table 15 is tested to reciprocate once or a plurality of times to detect the first and second positional information, and the fixed-point position is calculated based on these positional information, whereby allowing for acquiring the reference fixed-point positional information. The reference fixed-point positional information stored in the second storage unit 27 is read by the monitoring unit 29 at predetermined timing.

The reference fixed-point positional information does not necessarily have to be a value calculated by the calculation unit 26. At the time of calibration, an external measuring device may be used to measure the distance from the base point X00 to the reference axis CX (see FIG. 2), and the result may be stored as the reference fixed-point positional information in the second storage unit 27. As an example of an external measuring device, a laser displacement meter can be used. Alternatively, the base point X00 of the position detection unit 12 may be set when the table 15 is stopped at the reference axis CX. In general, the coordinate value of the base point X00 is set to zero, so the reference fixed-point positional information is zero, and zero should be stored in the second storage unit 27.

The fixed-point position selection unit 28 switches between the connection of the calculation unit 26 and the second storage unit 27, and the connection of the calculation unit 26 and the monitoring unit 29. When the fixed-point position selection unit 28 switches to the connection of the calculation unit 26 and the second storage unit 27, the reference fixed-point positional information calculated by the calculation unit 26 is stored in the second storage unit 27 when calibrating the fixed-point position. On the other hand, when the fixed-point position selection unit 28 switches to the connection of the calculation unit 26 and the monitoring unit 29, the fixed-point positional information calculated by the calculation unit 26 is sent to the monitoring unit 29 when monitoring the positional deviation.

The monitoring unit 29 determines whether the deviation between the fixed-point positional information calculated by the calculation unit 26 and the reference fixed-point positional information stored in the second storage unit 27 falls out of the prescribed range. If the monitoring unit 29 determines that the deviation between the fixed-point positional information acquired from the calculation unit 26 and the reference fixed-point positional information acquired from the second storage unit 27 falls within the prescribed range, the monitoring unit 29 notifies a normal state (the table 15 has no positional deviation) to a higher-level device (not illustrated) that controls the injection molding machine. On the other hand, if the monitoring unit 29 determines that the deviation between the fixed-point positional information acquired from the calculation unit 26 and the reference fixed-point positional information acquired from the second storage unit 27 falls out of the prescribed range, that is, determines that the amount of positional deviation of the table 15 exceeds the tolerance, the monitoring unit 29 notifies an abnormal state (the table 15 has a positional deviation) to the higher-level device that controls the injection molding machine. Thereafter, predetermined processing on abnormality is executed in the higher-level device.

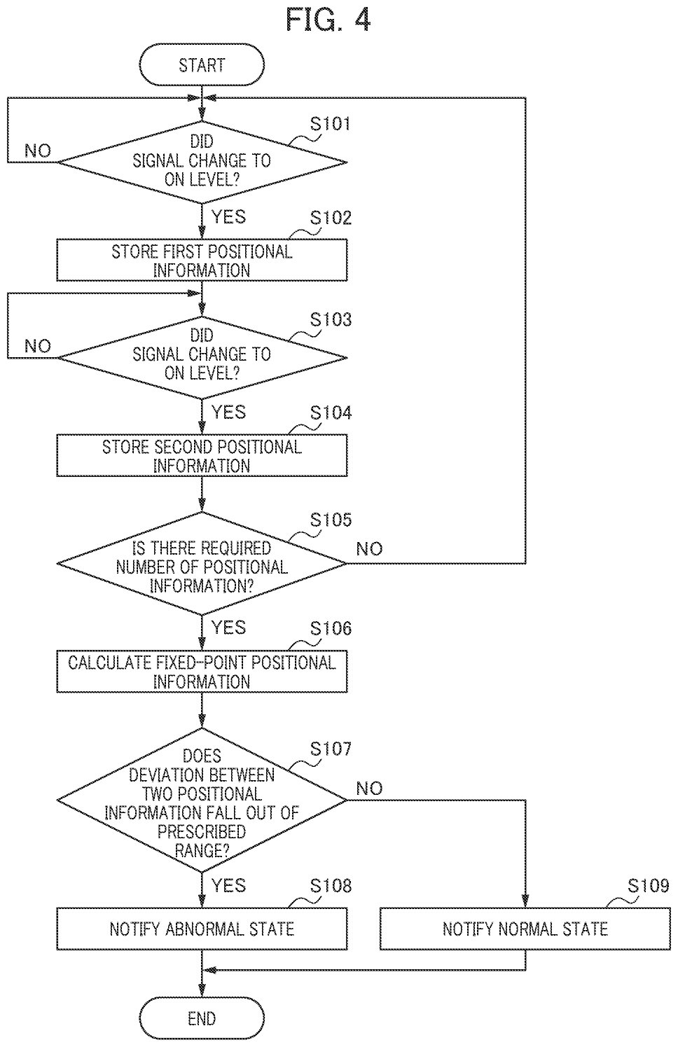

Next, a description will be provided on the procedure for detecting the positional deviation of the table 15 in the ejector device 1 according to the present embodiment. FIG. 4 is a flowchart illustrating the procedure for detecting the positional deviation of the table 15 in the ejector device 1 of the present embodiment. The reciprocating motion of the table 15 by the ball screw 14 is executed by sending an operation command generated by the command generation unit 24 to the control unit 21, so the description is omitted here.

In Step S101, the detection unit 23 determines whether the signal outputted from the proximity sensor 22 has changed from the OFF level to the ON level. In Step S101, if the detection unit 23 determines that the signal outputted from the proximity sensor 22 has changed from the OFF level to the ON level, the processing proceeds to Step S102. On the other hand, in Step S101, if the detection unit 23 determines that the signal outputted from the proximity sensor 22 has not changed from the OFF level to the ON level, the processing returns to Step S101.

In Step S102 (Step S101: YES), the detection unit 23 sends a detection signal to the command generation unit 24 and the first storage unit 25. As a result, the first positional information is stored in the first storage unit 25.

In Step S103, the detection unit 23 determines whether the signal outputted from the proximity sensor 22 has changed from the OFF level to the ON level. In Step S103, if the detection unit 23 determines that the signal outputted from the proximity sensor 22 has changed from the OFF level to the ON level, the processing proceeds to Step S104. On the other hand, in Step S103, if the detection unit 23 determines that the signal outputted from the proximity sensor 22 has not changed from the OFF level to the ON level, the processing returns to Step S103.

In Step S104 (Step S103: YES), the detection unit 23 sends a detection signal to the command generation unit 24 and the first storage unit 25. As a result, the second positional information is stored in the first storage unit 25.

In Step S105, the calculation unit 26 determines whether the required number of the first and second positional information has been stored in the first storage unit 25. In Step S105, if the calculation unit 26 determines that the required number of the first and second positional information has been stored in the first storage unit 25, the processing proceeds to Step S106. In Step S105, if the calculation unit 26 determines that the required number of the first and second positional information has not been stored in the first storage unit 25, the processing returns to Step S101.

In Step S106, the calculation unit 26 calculates, as the fixed-point positional information, the fixed-point position of the detection area S of the proximity sensor 22 when monitoring the positional deviation, based on the first and second positional information stored in the first storage unit 25, and sends this to the monitoring unit 29.

In Step S107, the monitoring unit 29 determines whether the deviation between the fixed-point positional information calculated by the calculation unit 26 and the reference fixed-point positional information stored in the second storage unit 27 falls out of the prescribed range. In Step S107, if the monitoring unit 29 determines that the deviation between the fixed-point positional information and the reference fixed-point positional information falls out of the prescribed range, the processing proceeds to Step S108. On the other hand, in Step S107, if the monitoring unit 29 determines that the deviation between the fixed-point positional information and the reference fixed-point positional information does not fall out of the prescribed range, the processing proceeds to Step S109.

In Step S108 (Step S107: YES), the monitoring unit 29 notifies an abnormal state (the table 15 has positional deviation) to the higher-level device that controls the injection molding machine. After completing Step S108, the processing of this flowchart ends.

In Step S109 (Step S107: NO), the monitoring unit 29 notifies a normal state (the table 15 has no positional deviation) to the higher-level device that controls the injection molding machine. After completing Step S109, the processing of this flowchart ends. In Step S107, if the monitoring unit 29 determines that the deviation between the fixed-point positional information and the reference fixed-point positional information does not fall out of the prescribed range, the processing of this flowchart may end without the monitoring unit 29 notifying a normal state to the higher-level device that controls the injection molding machine.

According to the moving-body monitoring device 2 of the present embodiment described above, for example, the following effects can be achieved. In the moving-body monitoring device 2 of the present embodiment, the calculation unit 26 calculates a fixed-point position, based on the first and second positional information detected when the table (moving body) 15 reciprocates in two directions. Therefore, even if the size of the detection area S of the proximity sensor 22 changes, the fixed-point position can be accurately calculated without being affected by the hysteresis. Accordingly, even if the size of the detection area S changes due to the factors such as environmental temperature and power supply voltage, the fixed-point position can be accurately calculated without being affected by the hysteresis, whereby further improving the accuracy of detecting the positional deviation of the table 15.

Here, a specific example is described below. Suppose at the installation location of the ejector device, the temperature difference of the environmental temperature is 40 degrees Celsius throughout the year, and the rate of change in the detection distance (operating range) of the proximity sensor is 12% in absolute value. Consider an inexpensive square proximity sensor commonly available in the market with a side length of 17 mm, taking this side length as the standard for detection distance; in this case, the fluctuation range of the detection distance due to environmental temperature will be a maximum of 17 mm×0.12≈2 mm. If the hysteresis of the proximity sensor is 10% of the detection distance, the error due to the hysteresis in the position detected when moving the moving body in one direction will be 2 mm×0.10×½=0.1 mm.

On the other hand, in an ejector device used in a small injection molding machine, if the number of teeth on the driven pulley is 40 and the travel pitch of the ball screw is 10 mm, the travel distance of the ball screw per tooth of the driven pulley will be 10/40=0.25 mm. If this value is the minimum amount of positional deviation to detect, the positional deviation cannot be accurately detected if there are fluctuations in detection distance or errors due to the hysteresis. However, according to the moving-body monitoring device 2 of the present embodiment, fluctuations in detection distance or errors due to the hysteresis can be eliminated, further improving the accuracy of detecting the positional deviation of the moving body.

According to the moving-body monitoring device 2 of the present embodiment, the proximity sensor that detects passage of the table 15 at a specific position is used; therefore, the presence or absence of a positional deviation of the table 15 can be determined by inexpensive means. According to the moving-body monitoring device 2 of the present embodiment, the monitoring unit 29 determines whether the deviation between the fixed-point positional information calculated based on one or a plurality of the first and second positional information and the reference fixed-point positional information calculated when calibrating the fixed-point position falls out of the prescribed range. As a result, the impact of variations in the fixed-point positional information calculated by the calculation unit 26 can be eliminated; therefore, the presence or absence of a positional deviation of the table 15 can be determined more accurately.

While the embodiment of the present invention has been described above, the present invention is not limited to the embodiment, and various modifications and changes can be made as illustrated in the modified embodiments described below, all of which are included within the technical scope of the present invention. The effects described in the embodiment are merely a list of the most preferable effects arising from the invention and are not limited to those described in the embodiment. The above-described embodiment and the modified embodiments described below can be used in combination as appropriate, but detailed descriptions are omitted.

### Modified Embodiment

In the embodiment, an example has been described where the detection unit 23 outputs a detection signal of the table (moving body) 15 when the signal outputted from the proximity sensor 22 changes from the OFF level to the ON level; however, this is not limited. The detection signal of the table 15 may also be outputted when the signal outputted from the proximity sensor 22 changes from the ON level to the OFF level.

In the embodiment, an example has been described where the proximity sensor 22 for detecting a positional deviation of the table 15 is provided near the ball screw 14; however, this is not limited. A proximity sensor for checking the retraction of the ejector rod (not illustrated) may also be used as the proximity sensor 22 in combination. By adopting such a configuration, the cost of the monitoring device can be reduced.

### EXPLANATION OF REFERENCE NUMERALS

1: ejector device, 2: moving-body monitoring device, 10: movable mechanism, 11: motor, 12: position detection unit, 13: power transmission unit, 14: ball screw, 15: table (moving body), 20: control device, 21: control unit, 22: proximity sensor, 23: detection unit, 24: command generation unit, 25: first storage unit, 26: calculation unit, 27: second storage unit, 28: fixed-point position selection unit, 29: monitoring unit

1. A monitoring device for a moving body that reciprocates in a first direction and a second direction opposite to the first direction, the monitoring device comprising:
a position detection unit that detects a position of the moving body and outputs the position as positional information;
a proximity sensor that detects passage of the moving body at a specific position;
a first storage unit that stores a position of the moving body when the moving body moving in the first direction is detected by the proximity sensor, as first positional information, and stores a position of the moving body when the moving body moving in the second direction is detected by the proximity sensor, as second positional information;
a calculation unit that calculates a fixed-point position in a detection area of the proximity sensor during monitoring, as fixed-point positional information, based on at least one of the first positional information and at least one of the second positional information stored in the first storage unit;
a second storage unit that stores reference fixed-point positional information; and
a monitoring unit that determines that an amount of positional deviation of the moving body exceeds tolerance when a deviation between the fixed-point positional information calculated by the calculation unit when monitoring the moving body and the reference fixed-point positional information stored in the second storage unit falls out of a prescribed range.

2. The monitoring device according to claim 1,
wherein the second storage unit stores fixed-point positional information calculated by the calculation unit when calibrating a fixed-point position, as reference fixed-point positional information.

3. The monitoring device according to claim 1,
wherein, when the proximity sensor detects that the moving body moving in the first direction has entered the detection area of the proximity sensor, the first storage unit stores the position of the moving body as first positional information, and
when the proximity sensor detects that the moving body moving in the second direction has entered the detection area of the proximity sensor, the first storage unit stores the position of the moving body as second positional information.

4. The monitoring device according to claim 2,
wherein, when the proximity sensor detects that the moving body moving in the first direction has entered the detection area of the proximity sensor, the first storage unit stores the position of the moving body as first positional information, and
when the proximity sensor detects that the moving body moving in the second direction has entered the detection area of the proximity sensor, the first storage unit stores the position of the moving body as second positional information.
